(19) United States
(12) Patent Application Publication
(10) Pub. No.: US 2014/0229486 A1
(43) Pub. Date: Aug. 14, 2014

(54) METHOD AND APPARATUS FOR UNSUPERVISED LEARNING OF MULTI-RESOLUTION USER PROFILE FROM TEXT ANALYSIS

(71) Applicant: THOMSON LICENSING, Issy de Moulineaux (FR)

(72) Inventors: Branislav Kveton, San Jose, CA (US); Yoann Pascal Bourse, Estrees (FR); Gayatree Ganu, Piscateway, NJ (US); Osnat Mokryn, Haifa (IL); Christophe Diot, Palo Alto, CA (US)

(73) Assignee: Thomson Licensing, Issey Les Moulineaux (FR)

(21) Appl. No.: 14/345,955

(22) PCT Filed: Sep. 28, 2012
(86) PCT No.: PCT/US12/57857

§ 371 Date: Mar. 20, 2014

Related U.S. Application Data
(60) Provisional application No. 61/541,458, filed on Sep. 30, 2011.

(51) Int. Cl. G06F 17/30

(52) U.S. Cl. CPC G06F 17/30705
USPC 707/737

(57) ABSTRACT

A method and apparatus for retrieving information from a massive amount of user-written businesses reviews are described. From the bag of words of a given review set, a graph based on mutual information between the words is built. Spectral analysis on this graph enables creation of a Euclidean space specific to those reviews where the distance corresponds to semantic proximity. Applying a cover-tree based divisive hierarchical clustering in this space yields therefore a semantic tag tree. Such a taxonomy is specific of the review set used, which could be all the reviews about a product or written by a user, and can be used for profiling. These taxonomies are used to build profiles. Also described is a tool to summarize and browse the review set based on the obtained trees.

### CROSS-REFERENCE TO RELATED APPLICATIONS

This application claims the benefit of the filing date of the following U.S. Provisional Application, which is hereby incorporated by reference in its entirety for all purposes: Ser. No. 61/541,458, filed on Sep. 30, 2011.”

### TECHNICAL FIELD

The present disclosure involves processing of information included in a database.

### BACKGROUND

The development of the web has boosted the production of content by users. Users are encouraged to express their opinion on various products or businesses by writing reviews about them, whether on e-commerce website such as Amazon or online reviewer communities like Yelp or IMDB. It is difficult to obtain any official statistics, but Yelp has for instance revealed recently that it contained more than 15 million reviews, with 41 million monthly visitors.

The text reviews are a very rich source of information which can provide businesses a useful feedback, but also other consumers various information about the product from a variety of different point of views. This allows a view of the product without the inherent bias of advertisement and can underline uncommon characteristics or details which might have been left out of a simple description.

This diversity of content is unfortunately submerged into the redundancy of the multitude of reviews. Browsing all this text then becomes a tedious task for a user, who will observe a lot of redundancy and might miss important information.

A solution to capture the diversity in the text is to automatically explore and mine the data. Certain research has focused on the star rating accompanying these reviews to provide the user with personalized recommendation, either based on the features of the product or the tastes of the people similar to the user, thereby removing the need to read reviews.

Star ratings-based analysis does not, however, provide the user with the description of the product they might have wanted, nor the businesses with the aforementioned feedback. This problem is addressed by review summarization which aims at selecting the most important information out of this mass of reviews and provides an exhaustive overview of the product.

Both of these tasks rely on detection of the product features. Manual tagging is obviously very tedious, does not scale well, and does not transfer to other domains. It is subjective and can be partial. A trained learning algorithm will show the same drawbacks. Furthermore, any automatic processing on these data is very difficult considering the nature of the user-written content as described further below. This is especially true of totally unsupervised methods. Strict natural language processing methods fail to account for the loose grammar, the colloquial language or frequent misspelling of such user-produced texts.

A simple straightforward unsupervised approximation is to consider the most frequent nouns as features. Yelp for example uses this method to highlight a few particularities of a restaurant. This kind of method is however insufficient to account for the fact that people use several words to talk about the same subject. For instance, they might use “atmosphere” or “ambiance” to describe the general feeling of a restaurant. Synonym detection is not enough: “bill” and “price” deal with the same concept but are not strictly synonyms, and will therefore not be grouped together. Moreover, the concepts are not all on the same semantic level. “food” is for example a generalization for “chicken”, “shrimp” or “soup” in a restaurant review.

Certain existing predefined taxonomies such as Wordnet might be used to address one or more of the described problems. But, such predefined taxonomies might lack some domain-specific words, such as dish names in the above-discussed restaurant-review based example. Also, the semantic relations of interest are domain-specific: it is very unlikely to find “murgh” in any taxonomy, let alone as a synonym of chicken. Furthermore, words can have totally different meanings in various contexts: “app” is the short for appetizer in a restaurant review but will stand for application in a review of a phone. There is no existing exhaustive taxonomy answering all these problems, and manually building one is quite tedious, if at all possible.

The ever growing quantity of user-produced content on the web has led to research on analysis of unstructured or semi-structured textual data. This is especially true for reviews about products or businesses due to the clear potential monetary value of such information. The desired end result could be review summarization, sentiment analysis or recommendation. Regardless of the end result, topic detection and organization are main challenges to address.

Existing review analysis techniques usually proceed in two steps. First, they detect the various features of the product mentioned by the user, and then they estimate their sentiment towards it. Various techniques have been used for review summarization, but most of them only consist in picking up a few significant sentences. That does not produce a usable profile definition. Some achieve useful results in word/features clustering but rely on a very heavy supervision, such as predefined classes. Others may extract features and evaluate the sentiment towards each of them, but they lack any kind of overlaying structure between these features. Moreover, such approaches are less efficient with low-frequency or abstract terms, which often constitutes the particularities of a profile and hence are not to be neglected.

### SUMMARY

An aspect of the present disclosure involves a method for automatically analyzing a database of textual information associated with user reviews, the method comprising the steps of selecting words in the database exhibiting a characteristic; processing the selected words to produce a graph representing a relationship between the selected words; and applying spectral analysis comprising cover tree based divisive hierarchical clustering to the graph for creating clusters of the selected words arranged in a tree comprising multiple levels wherein each level comprises thematically coherent ones of the clusters.

Another aspect of the disclosure involves apparatus comprising a pre-processor for selecting words included in a database of textual information associated with user reviews and having a characteristic; a word graph generator for processing the selected words to produce a graph representing a relationship between the selected words; and a word graph analyzer for performing a spectral analysis on the word graph to determine a structure of the graph wherein

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 shows in block diagram form an exemplary embodiment of apparatus for analyzing textual information in accordance with the present disclosure;

FIG. 2 shows additional details of a portion of the apparatus shown in FIG. 1;

FIG. 3 shows in flowchart form an exemplary method for processing textual information in accordance with the present disclosure;

FIG. 4 shows in flowchart form an exemplary method in accordance with the present disclosure;

FIG. 5 shows an example of data suitable for processing in accordance with the present disclosure;

FIG. 6 shows an example of a word graph produced in accordance with the present disclosure;

FIG. 7 shows an example of word clustering produced in accordance with the present disclosure;

FIG. 8 shows an example of a cover tree produced in accordance with the present disclosure; and

FIG. 9 shows an example of a word tree produced in accordance with the present disclosure.

It should be understood that the drawings are for purposes of illustrating the concepts of the disclosure and is not necessarily the only possible configuration for illustrating the disclosure.

### DETAILED DESCRIPTION

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventors to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

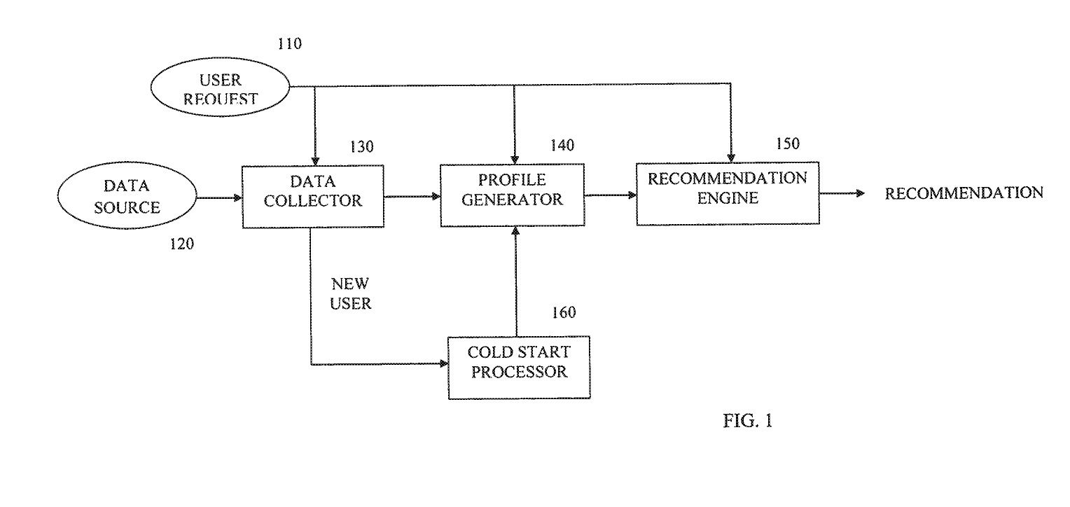

In FIG. 1, a data source 120 provides data input to a data collector 130 that creates a data set or data base suitable for processing as described herein. As explained above, an example of data source comprises user reviews of restaurants that are available on the internet. An exemplary embodiment of data collector 130 comprises a data crawler operating on 500k user reviews from a popular business reviewing website. The exemplary operation of data collector 130 provides a complete review list of about 1k users and 3k businesses. Although most of the reviews are about restaurants, about 30% deal with other businesses (bars, grocery stores, museums). Every textual review is associated with a unique star rating and corresponds to the opinion of one defined user about a given business. For generality purposes, no additional meta-data is used enabling the described apparatus and method to also operate on datasets other than that of the described exemplary embodiment.

It is noteworthy that this dataset is particularly dense: the average number of reviews written by a user is 162.4 (standard deviation of 271.6), with a maximum of 3800 reviews for some users. 35% users write more than 100 reviews and 80% more than 10. The review sizes vary a lot but are also fairly high, with an average of 810.0 characters (and a standard deviation of 656.6).

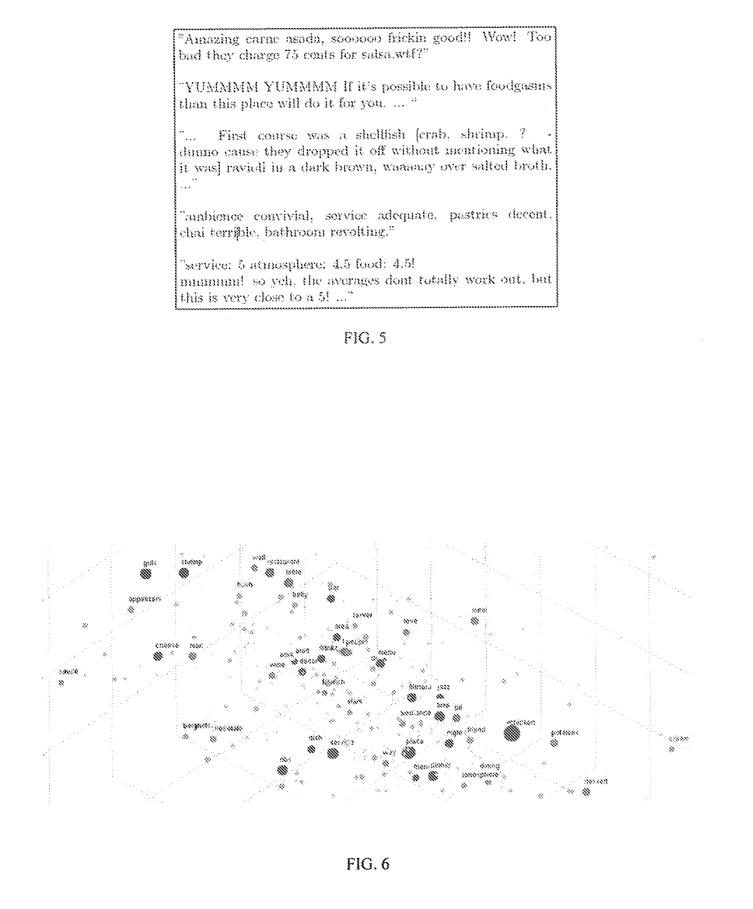

An example of the data set obtained by data collector 130 is shown in FIG. 5. The data set comprises user reviews that are user-written, and hence contain misspellings, grammatical mistakes, random punctuation, abbreviations, colloquial language, writing idiosyncrasies, highly specific or made-up vocabulary. The data processing described herein must process a variety of writing styles, making information retrieval and text analysis relying on strict rules difficult.

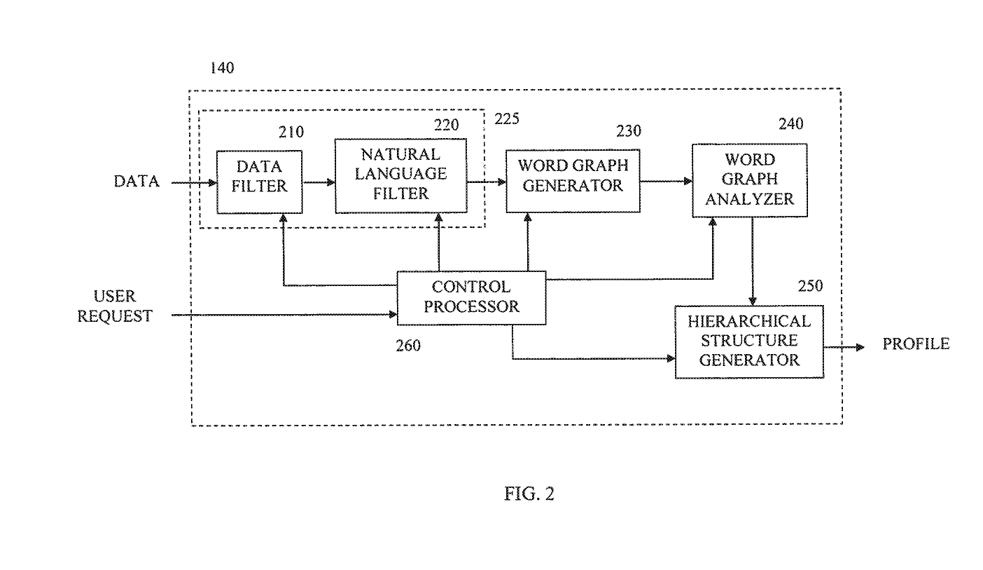

Therefore, an aspect of the present disclosure relates to data processing involving a flexible bag of words representation. The data set produced by data collector 130 is next analyzed by profile generator 140 in FIG. 1. However, before moving on to any analysis, an important pre-processing is applied to the textual data. Further details of profile generator are shown in FIG. 2. More specifically, FIG. 2 shows profile generator 140 comprising a pre-processor 225 including data filter 210 and natural language filter 220. Pre-processor 225 operates on the textual data to select words exhibiting a particular characteristic. For example, data filter 210 operates with natural language filter 220 to select words comprising a characteristic of being alphabetic, not a usual stop word, more than one or two letters, occurring more than five times in the dataset, and being a noun. More specifically, data filter 210 filters or eliminates any non-alphabetical characters, removes the usual stop words, removes the words of 1 or 2 letters, and removes the words appearing less than 5 times out of the whole dataset, which are likely misspellings or irrelevant artifacts. Following data filter 210, natural language filter 220 operates to identify the nouns in the data set which are likely to have a stronger thematic meaning. An exemplary embodiment of natural language filter 220 comprises tagging with the open-source toolkit openNLP. Finally, natural language filter 220 chunks the reviews into sentences in accordance with an aspect of the present disclosure involving an assumption that sentences are likely to be thematically coherent, and hence that two words in a same sentence are likely to deal with the same subject.

Next, profile generator 140 of FIG. 1 comprises a word graph generator 230 as shown in FIG. 2. Word graph generator 230 builds a graph on top of the bag of words of the reviews for a given user or business, whose nodes are the distinct words selected by pre-processor 225 and linked if they occur together in one sentence. That is, the graph constructed by word graph generator 230 represents a relationship between the selected words.

In the graph generated by word graph generator 230, the links are weighted to account for the number of co-occurrences between the words, but in order not to favor frequent words which would link everything together, a score based on mutual information is used as follows:

$$score ( i , j ) = log ( \frac{\vert {S}_{i} ⋂ {S}_{j} \vert}{\vert {S}_{i} \vert \vert {S}_{j} \vert} ) \qquad ( 1 )$$

where |Sᵢ| is the number of sentences containing the word i, and |Sᵢ∩Sⱼ| is the number of sentences in which i occurs with j.

Various approaches to weighting of the edges exist. However, point-wise mutual information typically provides good results.

In order to find some structure over this graph, the output of word graph generator 230 is processed by word graph analyzer 240 which implements spectral clustering that is a deterministic, fast and efficient clustering without any supervision. Such clustering relies on the spectral analysis of the graph to find the smoothest functions and cluster them to highlight the strongly connected parts of the graph.

Word graph analyzer 240 first projects the graph into a high dimensional Euclidean space. A goal is to preserve the proximity of two nodes in the weighted graph. Therefore, the processing looks for axes of this space as functions f that minimize:

$$\frac{1}{2} {\sum }_{i , j = 1}^{n} {{w}_{i , j} ( \frac{{f}_{i}}{\sqrt{{d}_{i}}} - \frac{{f}_{j}}{\sqrt{{d}_{j}}} )}^{2} \qquad ( 2 )$$

Dividing the degree ensures that the nodes are considered equally, that is to say that the most common words (highest degree) are not favored. In order to do so, if W is the weighted adjacency matrix of the aforementioned graph, and D the diagonal degree matrix such that

$${d}_{i , i} = {\sum }_{j = 1}^{n} {w}_{i , j} \qquad ( 3 )$$

and the normalized Laplacian is defined as:

L=I−D^{-1/2}WD^{-1/2} (4)

whose eigenvectors correspond to the smooth functions on the graph minimizing the Equation (2). The eigenvectors are orthogonal and each captures thereby different information about the graph.

Solutions to this problem include the functions indicative of unconnected or barely connected components (containing one or a few words), which overweight these outlying words. Therefore, it is necessary to eliminate the smallest eigenvectors corresponding to these smoothest functions, in order to keep only the relevant ones. This can be achieved by a threshold on the eigenvalue, as the eigenvalue a corresponds to:

$$α = {f}^{T} Lf = \frac{1}{2} {\sum }_{i , j = 1}^{n} {{w}_{i , j} ( \frac{{f}_{i}}{\sqrt{{d}_{i}}} - \frac{{f}_{j}}{\sqrt{{d}_{j}}} )}^{2} \qquad ( 5 )$$

Furthermore, only a \sqrt{N} eigenvectors are kept, corresponding to the most meaningful functions, where N is the number of different words. This choice is enough to capture the variability in the data while getting rid of the noise. The results are however invariant with respect to small changes to this quantity. Finally, the axes of the obtained \sqrt{N}-dimensional space are normalized.

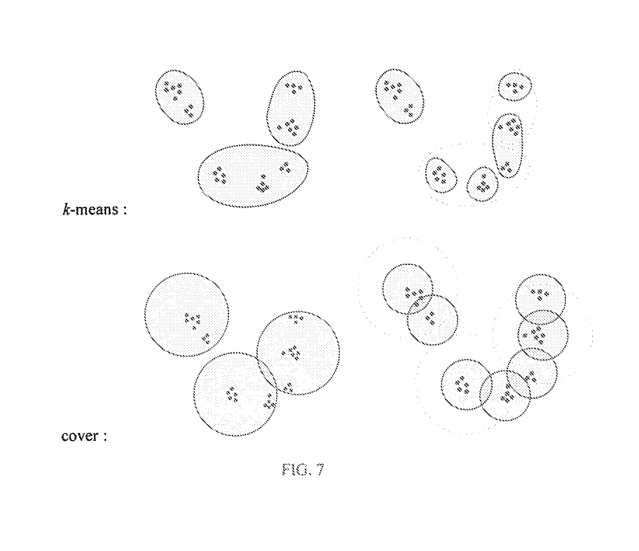

The results show that when projecting the words in the space whose axes are the selected eigenvectors, proximity in the resulting Euclidean space do correspond to thematic proximity, as expected. The overall structure seems like a ball from which bulges about certain topics arise in several dimensions. A three-dimensional projection can be seen on FIG. 6. In FIG. 6, the axes, eigenvectors of the Laplacian matrix, have no particular semantic meaning, but thematic clusters such as dessert, ambiance or cold food appear. The color and size of the points correspond to the frequency of the words.

An approach for spectral clustering comprises applying in this space a k-means clustering algorithm. Using a k-means clustering has however the major drawback to require a manual and arbitrary pick of a single k, which might not be the most meaningful, and will most likely vary for different users or businesses. Furthermore, varying this k can change the whole structure of the clustering, making it impossible to control granularity in a non-chaotic way, as illustrated by FIG. 7. More specifically, FIG. 7 shows the effect of granularity change over k-means clustering and cover tree clustering. In accordance with aspects of the present disclosure, cover tree clustering is utilized as described herein resulting in the smaller clusters being clearly attached to a bigger parent. In contrast, varying the k in k-means does not provide any consistency, and can for instance group together points that were separated before. Finally, k-means does not account for cluster overlapping which is likely in text analysis.

Instead, in accordance with the present disclosure, the exemplary embodiment shown in FIG. 2 comprises hierarchical structure generator 250 that processes the output of word graph analyzer 240 to provide a divisive hierarchical clustering in order to obtain multiple levels of granularity and to eliminate the arbitrary choice of k. More specifically, the described apparatus and method apply a cover-tree based divisive hierarchical clustering to build a cover tree over the semantic space to reflect its semantic geometrical properties, in order to obtain the desired taxonomy. A cover tree on data points x₁, . . . , xₙ is a rooted infinite tree that satisfies four properties. First, each node of the tree is associated with one data point. Second, if a node is associated with the data point xᵢ, then one of its children must be also associated with xᵢ. Third, nodes at depth j are at least ½^{j} apart from each other. Finally, each node at depth j+1 is within ½^{j} of its parent xᵢ at depth j. By induction, each node in the subtree rooted at xᵢ is within ½^{j-1} of xᵢ.

Cover trees have many advantages. First, they allow for variable discretization of data. In particular, if j is the deepest level of the tree with no more than k nodes, then the nodes at depth j cover the set {xₜ}ⁿₜ₌₁ within an error of 8d({xₜ}ⁿₜ₌₁, S*) where S* is the optimal coverage of size k. Herein these nodes are referred to as representative states. Note that the above bound holds for all k≦n and therefore, the granularity of discretization does not have to be chosen in advance. This is not the case for k-means and online k-center clustering.

Second, cover trees can be built incrementally, one node at a time. In particular, when a new example Xₙ₊₁ arrives, it is added as a child of the deepest node xᵢ such that d(xₙ₊₁, xᵢ)≦½^{j}, where j is the level of xᵢ. This simple update takes O(log n) time and maintains all four invariants of the cover tree.

Finally, note that a cover tree on n data points can be built in O(n log n) time. Thus, when k>log n, the tree can be built faster than performing k-means or online k-center clustering.

A cover tree is constructed in the space of words by feeding it the words ordered by decreasing frequency. In accordance with aspects of the method and apparatus described herein, the most frequent words tend to be high in the tree. Frequent words will always be parents of infrequent words. Every level refines precision and reduces the radius of the balls, dividing the previous clusters.

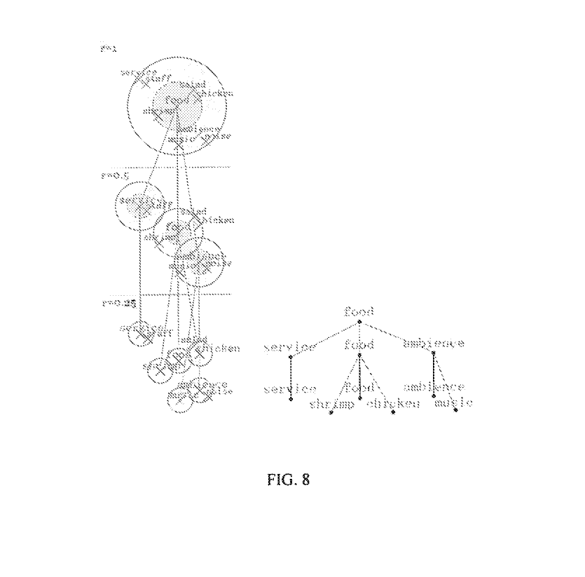

An exemplary cover tree constructed in accordance with the present disclosure is shown in FIG. 8. The left side of FIG. 8 shows a structure produced by hierarchical structure generator 250 as described above including multiple levels with more frequent words at higher levels and radius of the balls decreasing from the top level to the bottom level. The right side of FIG. 8 shows the resulting tree.

The rich structure built automatically from the text for a given user or restaurant provides a detailed profile at the output of hierarchical structure generator 250 in FIG. 2. That profile can be used, for example as an input to a recommendation engine, such as recommendation engine 150 in FIG. 1. A recommendation engine may compare one profile to another and make a recommendation to a user in accordance with the results of the comparison. For example, a user may submit a request such as user request 110 in FIG. 1. The user request may be for a restaurant recommendation. A profile of the user may be generated by profile generator 140 responsive to the user request. The user profile may then be compared in recommendation engine 150 to one or more other profiles such as a business profile, e.g., a restaurant profile, in order to do functions such as matchmaking that lead to a recommendation for the user.

As described, providing such a recommendation involves a comparison of profiles. Profiles as described herein comprise trees that are organized sets of word clusters of different sizes. To compare two trees, the clusters of words which compose them are compared. Therefore, an elementary comparison operation between two of the clusters is defined.

An exemplary embodiment of the comparison included in recommendation engine 150 of FIG. 1 comprises determining a cosine similarity between two clusters considered as bags of words as a measure to compare them. Let a cluster N be represented by a normalized vector \vec{n} over the set W of all words, its i^{th} coordinate nᵢ being the frequency of occurrence of wᵢ in the whole corpus, in such a way that it gives a higher weight to more important words. With this definition, the comparison score of two clusters M and N will be:

$$s ( N , M ) = \frac{〈 \vec{n} , \vec{m} 〉}{‖ \vec{n} ‖ ‖ \vec{m} ‖} = 〈 \vec{n} , \vec{m} 〉 \qquad ( 6 )$$

since the vectors over the bag of words are normalized.

The score (6) is used to compute a similarity score between two profiles. The profiles are considered level by level, the first level being the root (hence the bag of words of the whole corpus). However, two trees might not have the same number of clusters at the same level. In such a situation, it is possible to approximate the optimal matching between the two clusters set by the following algorithm:

For each cluster in the tree 1, find the best match (higher score) at the same level in the tree 2, and then do the same with the clusters of the tree 2.

This gives a set C of chosen cluster pairs, from which the similarity score can be obtained using the elementary operation s defined in (6) as follows:

$$S ( {T}_{1} , {T}_{2} ) = \frac{{\sum }_{( {c}_{1} , {c}_{2} ) ∈ C} s ( {c}_{1} , {c}_{2} ) \vert {c}_{1} \vert \vert {c}_{2} \vert}{{\sum }_{( {c}_{1} , {c}_{2} ) ∈ C} \vert {c}_{1} \vert \vert {c}_{2} \vert} \qquad ( 7 )$$

where |c| is the size of the cluster c (that is to say the number of non-zero components of the bag of words vector).

The scores obtained at all the different levels are then merged in a linear combination to yield a final compatibility score. The weights of this combination may be learned on a training set.

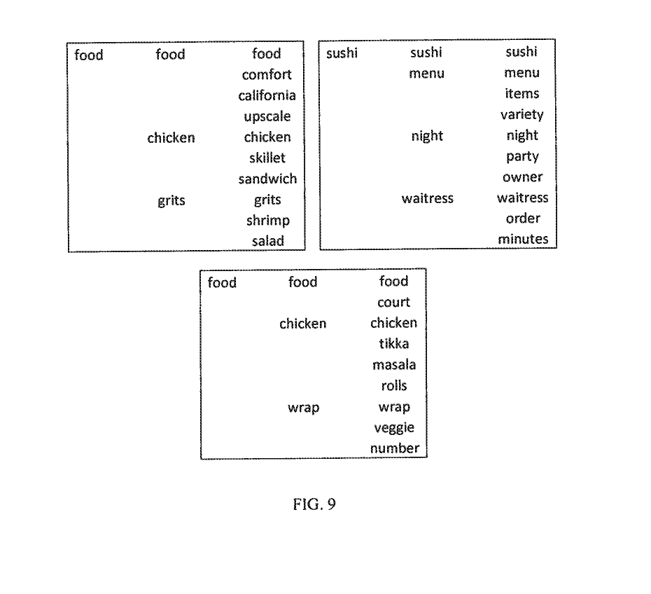

The trees of topics constructed as described above capture very interesting properties of the text and can be regarded as profiles for a business or a user. The most important words are at the top of the tree, and the words which are semantically close are close in the tree. Furthermore, the tree structure enables the covering of all the aspects of a given text set, and offers a nice control over granularity. Examples of such trees are displayed in FIG. 9 where the trees of words are representative of the particularities of restaurants. The specific example in FIG. 9 shows an extract at level 3 of the obtained trees for a French soul-food lounge, a Japanese restaurant and an Indian/Pakistani fast-food restaurant.

In accordance with the present disclosure, the described apparatus and method may be used to build one tree per restaurant and use the tree as a browsable representation of the restaurant's reviews.

Indeed, if the nodes of the tree are displayed as sentences containing the maximal number of words from their subtree, this expandable tree can be viewed as a way to browse the corpus of text. The user can go deeper in the tree in the aspects they are interested in, while having an overview of the rest, and could access to the full review from which the sentences are extracted.

The apparatus and method described herein are not limited to the exemplary system described herein and, in particular, are not limited to the restaurant embodiment described herein. It can be used as input to any text-based recommendation or summarization engine. The detailed user profiles would be a basis for matchmaking or targeted advertisement. Adjusting the various scores and comparison process and the performances of the similarity metric would enable the described system to stand as a recommendation system by itself.

Other aspects comprise adding some additional information like a sentiment score for every concept and accounting for the particularities of a profile that distinguishes it from the average.

Another aspect comprises providing a cold start processor 160 in FIG. 1 for providing information suitable to enable the described system to create a profile for a new user. For example, cold start processor may cluster the user profiles to identify some archetypes useful for integrating new users into the system. Alternatively, cold start processor 160 may operate as a query engine as an entry point for the system. Also, searching for a keyword in a tree or for a toy example tree would enable the system to account for specific temporary demands or context-based preferences.

In addition, the described system could be expanded to build a taxonomy over the whole dataset to fashion an entire “restaurant” taxonomy which could be used as a baseline for profile definition. Indeed, it would provide every word in the cluster “seafood” and the system could know for a given user their interest and sentiment towards “seafood”, as well as finer grain or lower grain categories. Such a score on every level would provide a baseline for sentiment analysis.

The operation of the apparatus shown in FIG. 2 and described above may be controlled by a controller or control processor such as control processor 260 in FIG. 2. Control processor 260 is responsive to, for example, a user request for information such as a restaurant recommendation. In response to such a user request, control processor 260 controls the apparatus of FIG. 2 to produce a profile responsive to the user request. The resulting profile is then processed by recommendation engine 150 of FIG. 1 as described above to produce, e.g., a recommendation for the user.

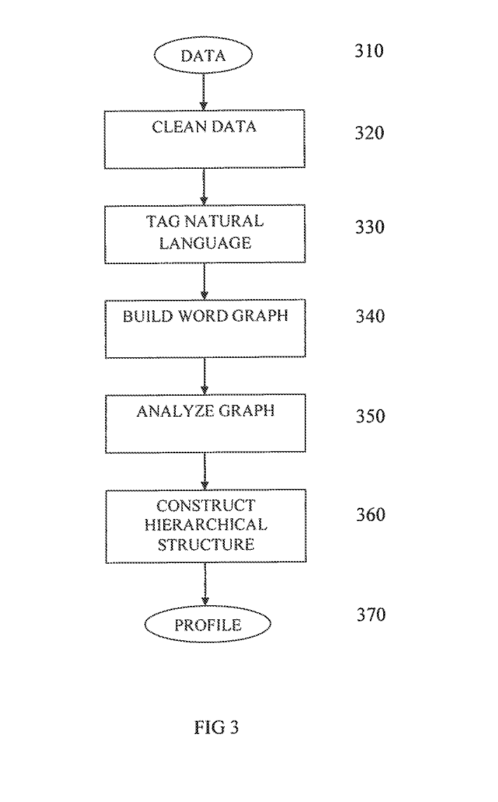

Another aspect of the present disclosure involves a method as depicted in flowchart form in FIG. 3 that may be implemented by the described apparatus of FIGS. 1 and 2. More specifically, in FIG. 3, at step 310 data, such as the above-described restaurant review data, is received for processing. Steps 320 and 330 pre-process the data for selecting words having a characteristic comprising being alphabetic, not a usual stop word, more than one or two letters, occurring more than five times in the dataset, and being a noun. More specifically, step 320 cleans or filters the data to eliminate any non-alphabetical characters, remove the usual stop words, remove words of 1 or 2 letters, and remove words appearing less than 5 times out of the whole dataset, which are likely misspellings or irrelevant artifacts. Step 330 operates on the output of the data cleaning of step 320 to tag the natural language by, for example, identifying the nouns in the data set which are likely to have a stronger thematic meaning The tagged natural language produced by step 330 is processed at step 340 to build a word graph representing a relationship between the selected words as described above in regard to word graph generator 230 of FIG. 2. The word graph produced at step 340 is analyzed at step 350 by, for example, spectral clustering involving cover trees as described above in regard to analyzer 240 of FIG. 2. Then, the output of step 350 is processed at step 360 which applies divisive hierarchical clustering as described above. The result of the method in FIG. 3 is a profile produced at step 370 that may be used as an input to recommendation engine 150 of FIG. 1.

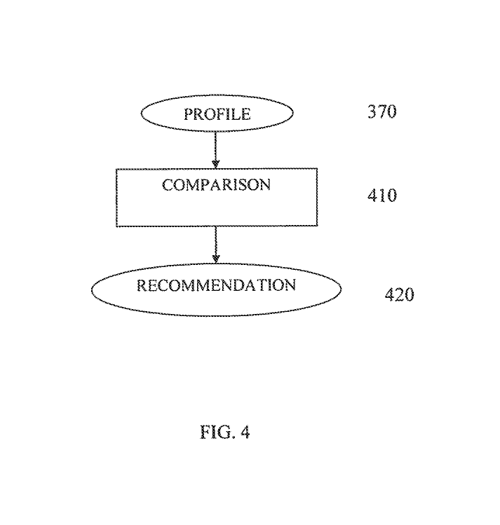

An exemplary method of operation of recommendation engine 150 is shown in FIG. 4. In FIG. 4, a profile produced in accordance with the present disclosure, e.g., the profile output of the apparatus of FIG. 2 or the output of the method of FIG. 3, undergoes a comparison at step 410 of FIG. 4. The comparison may occur as described above in regard to the operation of recommendation engine 150 to produce a recommendation at step 420.

Although embodiments which incorporate the teachings of the present disclosure have been shown and described in detail herein, those skilled in the art can readily devise many other varied embodiments that still incorporate these teachings. Having described embodiments of a method and apparatus for processing textual information (which are intended to be illustrative and not limiting), it is noted that modifications and variations can be made by persons skilled in the art in light of the above teachings. It is therefore to be understood that changes may be made in the particular embodiments disclosed which are within the scope of the disclosure as outlined by the appended claims.

1. A method for automatically analyzing a database of textual information associated with user reviews, the method comprising:
selecting words in the database exhibiting a characteristic;
processing the selected words to produce a graph representing a relationship between the selected words;
applying spectral analysis comprising cover tree based divisive hierarchical clustering to the graph for creating clusters of the selected words arranged in a tree comprising multiple levels wherein each level comprises thematically coherent ones of the clusters.

2. The method of claim 1 wherein the characteristic comprises multiple occurrences within the database.

3. The method of claim 1 wherein processing the selected words comprises linking words in the graph if they occur in one sentence included in the database and weighting the links in accordance with co-occurences between the linked words.

4. The method of claim 1 wherein the tree represents a first profile associated with a particular user;
repeating the method of claim 1 to produce a second tree and a second profile associated with a second user; and
comparing the first and second profiles to determine a similarity between the profiles.

5. The method of claim 4 wherein the step of comparing comprises determining a cosine similarity between a cluster of the first tree and a cluster of the second tree.

6. Apparatus comprising:
a pre-processor for selecting words included in a database of textual information associated with user reviews and having a characteristic;
a word graph generator for processing the selected words to produce a graph representing a relationship between the selected words; and
a word graph analyzer for performing a spectral analysis on the word graph to determine a structure of the graph wherein the spectral analysis comprises applying a cover tree based divisive hierarchical clustering for creating clusters of the selected words arranged in a tree and comprising multiple levels, each level comprising thematically coherent ones of the clusters.

7. The apparatus of claim 6 wherein the characteristic comprises multiple occurrences within the database.

8. The apparatus of claim 7 wherein the processing step comprises linking words in the graph if they occur in one sentence included in the database and weighting the links in accordance with co-occurences between the linked words

9. The apparatus of claim 6 wherein the tree represents a first profile associated with a particular user; and wherein the word graph generator processes the selected words for generating a second graph representing a second relationship between the selected words and the word graph analyzer processes the second graph for producing a second tree representing a second profile; and further comprising
a comparator for comparing the first and second profiles to determine a similarity between the profiles.

10. The apparatus of claim 9 wherein the comparator determines a cosine similarity between a cluster of the first tree and a cluster of the second tree.
